(19) United States
(12) Patent Application Publication
(10) Pub. No.: US 2007/0129970 A1
(43) Pub. Date: Jun. 7, 2007

(54) Method and apparatus for location and presentation of information in an electronic patient record that is relevant to a user, in particular to a physician for supporting a decision

(76) Inventor: Sultan Haider, Erlangen (DE)

Correspondence Address: SCHIFF HARDIN LLP;Patent Department, 6600 Sears Tower, 233 South Wacker Drive, Chicago, IL, 60606, US

(21) Appl. No.: 11/635,866

(22) Filed: Dec. 7, 2006

(30) Foreign Application Priority Data
Dec. 7, 2005 (DE) 10 2005 058 481.0

(51) Int. Cl. G06F 19/00; G06F 17/00

(52) U.S. Cl. 705/3; 706/54

(57) ABSTRACT

A method and apparatus for location and presentation of information in at least one electronic patient record that is relevant to a user, in particular relevant to a physician for supporting a decision or diagnosis, wherein depending on data with regard to at least one input of information into and/or a query of information from the electronic patient record by a user, a self-learning, intelligent algorithm of a data processing device automatically adapts the content and/or the presentation of the information provided to a user given a new input and/or a new query.

### BACKGROUND OF THE INVENTION

1. Field of the Invention

The present invention concerns a method for location and display of information in at least one electronic patient record that is relevant to a user, in particular to a physician for supporting a decision or diagnosis; the invention also concerns an associated apparatus.

2. Description of the Related Art

Electronic patient records that, for example, are held ready on the Internet or, respectively, in general on mobile or stationary storage units can under the circumstances contain a large quantity or set of information, for example a plurality of images that were generated with imaging medical examination apparatuses in preceding examinations of the patient and a plurality of reports and general information regarding the patient. Particularly for patients who exhibit a complex illness history, it can therefore be difficult (in particular under time pressure, for example when the patient is admitted into a clinic as an emergency patient) to locate the information that is important for a diagnostic and therapeutic decision quickly enough.

On the one hand, valuable time that would be important for the treatment of the patient can thereby elapse unused while, on the other hand, some information is re-acquired unnecessarily since it is not simple to locate in the electronic patient record although this information is already sufficiently up-to-date there. Under the circumstances, complicated examinations or, respectively, examinations stressing the patient are unnecessarily implemented another time.

### SUMMARY OF THE INVENTION

The present invention provides a method and apparatus that is improved in regard to location and presentation of information in at least one electronic patient record that is relevant to a user, in particular to a user for supporting a decision or diagnosis.

To solve this problem in the present method it is provided that, dependent on data with regard to at least one input of information into and/or a query of information from the electronic patient record by a user, a self-learning, intelligent algorithm of a data processing device automatically adapts the content and/or the presentation of the information provided to a user given a new input and/or a new query.

### BRIEF DESCRIPTION OF THE DRAWINGS

Further advantages, features and details of the invention result using the following exemplary embodiments as well as from the drawings.

FIG. 1 is a workflow diagram showing an embodiment of a method according to the principles of the present invention;

FIG. 2 is a block diagram showing a determination of a log file in an inventive method;

FIG. 3 is a block diagram showing input or, respectively, retrieval of information of an electronic patient record in an inventive method; and

FIG. 4 is a functional block diagram of a device according to the principles of the present invention.

### DETAILED DESCRIPTION OF THE PREFERRED EMBODIMENTS

Effective decision support for a decision about the further treatment of a patient or for generating a diagnosis is supplied to a user (for example to a physician in the emergency room). A self-learning, intelligent algorithm is implemented on a data processing device (such as a workstation or, respectively, a mobile computer such as a PDA (Personal Digital Assistant) or the like) or on a network of compute or, respectively, is accessible via an external storage medium such as a chip card in order to be executed on the data processing device. The algorithm processes various data that are connected with or associated with the retrieval of information from or, respectively, the input of information into an electronic patient record of one or more patients.

The term “self-learning, intelligent algorithm” is to be understood in the broadest sense, (for example) as a packet of various algorithms that can be separated from one another, which packet of various algorithms interact upon input of a query to adapt the provided information and thus provide the self-learning, intelligent algorithm of the present invention.

In a technical regard, the algorithm thereby effects a further processing of the data with regard to the information of the electronic patient record or, respectively, patient records, for example by providing grouping or, respectively, filtering. For this operation, links are established or, respectively, the physical storage in specific storage units is changed in order to utilize the knowledge and the work of a first user (for example of a physician who once made a therapeutic decision in the presence of specific symptoms and diagnostic questions) for a later access to the record of this patient or to records of patients with similar symptoms or, respectively, questions.

For example, the displayed content is therewith adapted dependent on the prior history or, respectively, the knowledge of earlier users given a new access to the patient record. This can mean that existing image exposures of an appertaining body part are shown upon input of, for example, a specific symptom. Additionally the order of the presentation can depend on how earlier users have accessed the corresponding image exposures. The offering of further documents or, respectively, information possibly ensues in a similar manner, such that (for example) information that is classified as particularly relevant is initially displayed or, respectively, can be retrieved particularly simply due to multiple preceding queries and inputs. In the framework of the invention the knowledge or, respectively, the work of a plurality of physicians is grouped with the aid of the self-learning, intelligent algorithm in order to distinctly simplify the location of information in a patient record (if applicable with access to further information databanks) for the individual physician. Synergistic effects are provided that are based on the fact that the algorithm changes or, respectively, adapts the information presentation or, respectively, the contents on the basis of a learning process whose foundations are the knowledge and the experience of many physicians or, respectively, experts as well as the data of a plurality of patients.

The data with regard to the input and/or the retrieval of information can be stored as structured data in a databank, in particular upon generation of at least one log file.

The data with regard to the input or, respectively, the retrieval of one or more items of information can on the one hand concern the information of the electronic patient record itself (thus its content, such as for example a new input or, respectively, new files that are to be added to the electronic patient record); on the other hand, these data can also concern further information going beyond the mere content of the record. For example, information concerning which files of which name are added and when then were added can be stored or, respectively, saved as such information, such that this current information or, respectively, these current files are offered to a further user of the record as paramount for retrieval or, respectively, for viewing, if applicable after a processing of these data by the algorithm. Furthermore, the data can be data that specify which information of the patient record or patient records were retrieved together or in connection with one another, whereby the data represent, for example, information regarding links or connections between different data items. The data can comprise specific inputs of a user that, for example, are linked in a log file with the contents that were considered. The data can additionally comprise further (possibly queried) information, for example an evaluation of the relevance of the content that a preceding user has made.

The databank is to be understood as a data collection and data storage in the broadest sense, with the purpose that a structured storage of the data is enabled for fast location of the same or, respectively, of the information of the electronic patient record. For this, the databank is linked in a suitable form with the electronic patient record. If applicable, the data for input or, respectively, for retrieval of information can be stored in a common databank structure with the electronic patient record.

The algorithm can adapt the content and/or the presentation of the information on the basis of the structured stored data of the databank. The system thus learns every time using the data selection from the electronic patient record or electronic patient records and thus supports the physician in subsequent examinations. For example, in the event that a radiologist conducts an examination at a later point in time, which examination corresponds in parts to an examination that was already conducted previously by a different physician, a protocol for implementation of the examination is automatically generated using the data presented to the algorithm with regard to the preceding examination and said protocol is made available to the physician. The algorithm can therewith optimize the workflow in the clinical environment. Content adaptations of the information of the electronic patient record can thus be implemented, for example in that information that are never queried are deleted after a specific time or, respectively, information that is present twice or is conflicting or contradictory information are merged and checked, if applicable after a query to the user. If applicable, an administrator or a medically knowledgeable coordinator can be provided for this. With the aid of the structure of the data of the databank, the presentation is, for example, adapted such that the physician or another user is directed through a workflow scheme or, respectively, protocol that has proven to be reasonable or suitable given preceding accesses.

For adaptation of the content and/or the presentation, the algorithm can establish relationships between the data with regard to the input and/or the retrieval of information and/or access that is predetermined and/or purchased or acquired knowledge. For example, relationships can be established between specific symptoms that are input on the user side and documents of the patient record, these relationships being seen or, respectively, evaluated as important. Links between individual data of the databank that possibly refer to documents of the patient record are thereby generated and possibly dissolved again in the further course of the learning process. The algorithm can additionally access predetermined knowledge in the form of rules or general information that, for example, are based in inquiries by physicians that were implemented in a representative manner or, respectively, are based on the content of medical data collections and information tools. The self-learning, intelligent algorithm additionally acquires suitable knowledge, on the one hand via the frequency of retrieval of specific information or documents of the patient records, for example, and on the other hand in that possible evaluations of the importance or relevance of documents by the individual users are queried or data regarding presentation changes or viewing times are collected for individual items of information.

Data of an electronic patient chart and/or patient attribute (in particular symptoms and/or diagnostic questions); and/or data regarding documents of an electronic patient record requested by a user; and/or data regarding documents stored in the electronic patient record (in particular after a follow-up examination); and/or data regarding a presentation type of information (in particular of a specific anatomical region and/or of a pathological finding) defined by a user; and/or data regarding data flow from and/or to the electronic patient record; and/or data regarding user preferences can thus be stored in a storage device (for example a databank as described in the preceding) as data with regard to the input and/or the retrieval of information.

For example, in the framework of an embodiment of the present invention, a databank acquires various mechanisms and techniques (for example for diagnosis finding), for example as a log file, entries and inputs of an electronic patient record such as, for example, demographic specifications with regard to a respective patient. Moreover, inputs of one or more physicians, for example patient attributes such as the symptoms or a series of diagnostic questions are used (and, if applicable, stored in the databank) as data regarding the input and/or the retrieval of information. Further data concern the documents requested by the respective user (thus for example the physician) and other information of the electronic patient record as well as the documents and information that, for their part, have been stored in the electronic patient record on the part of the physician, for example after a subsequent examination.

In addition to this data, the presentation status that has been selected by a user is advantageously stored, for example as a specification for a presentation type for viewing of specific anatomical regions or pathological findings.

Furthermore, the data can be directly related to the developer station or, respectively, to the transfer and the retrieval of data and information of the patient record, for example with regard to the type and the quantity of the newly input information in order to thus track the data flow, for example with a time correlation. For example, in a log file the indices or other identifiers of various files can be stored as options or sub-options. The files are retrieved from an electronic patient record or, respectively, are stored in the patient record, whereby links and connections to various attributes (such as demographic data, symptoms and diagnostic questions) are produced, for example by utilizing a predetermined databank structure with fields linked with one another or the like.

According to an embodiment of the invention, a protocol can be determined for the learning and/or the training and/or the data prediction on the part of the algorithm. The self-learning, intelligent algorithm monitors the data with regard to the retrieval or, respectively, the input of information (which data are, for example, stored in a log file or a general databank) and using these data the algorithm learns the relationships between various attributes that have been defined in the data storage. For example, the algorithm learns specific relationships between patient symptoms and diagnostic questions that respectively leads to an access to a specific type of information in the electronic patient record. Furthermore, the algorithm learns user preferences for which it uses predetermined knowledge and additionally accesses data regarding currently set user preferences. A standard or, respectively, default protocol or, respectively, sets of such protocols can thereby be determined that comprise the optimal settings, for example with regard to the user preferences for a presentation etc. In the further course, the learning or, respectively, the training of the algorithm as well as the further data prediction (for example with regard to the preferably retrieved information from the record) can therewith be supported by a preliminary determined protocol and in turn effect the improvement of the protocol.

A neural network and/or adaptive filter techniques and/or Bayesian techniques and/or a genetic algorithm can be used for determination of the protocol. If applicable, a plurality of techniques coupled with one another can be used, thus a plurality of neural networks or a connection of adaptive filter techniques with a genetic algorithm and the like can be used. The usage of these various techniques by the data processing device can possibly be adapted in the further course of the learning process in order to correspond to the current conditions. Ultimately, optimal settings for a standard protocol can thus be obtained.

Data with regard to the input and/or the retrieval of information, in particular data of a log file, can be stored on a storage medium, in particular on an electronic chip card, and/or in an electronic patient record. When stored in a patient record, the information is stored in a header of the electronic patient record. A read-write mechanism for the data storage device on which the data is stored accesses the electronic patient record and is therewith provided with the work steps that are carried out to perform the present method. The storage of these data can ensue on an electronic chip card or, respectively, a different memory chip, possibly in addition to the data storage in a databank. Such a memory chip can if applicable additionally be used for user authentication. For example, data that are particularly relevant with regard to the input or, respectively, the retrieval of information in or from the record can be stored on the memory chip or, respectively, as a header of the electronic patient record. These data can additionally be stored in a larger storage unit (possibly an additionally databank) or furthermore can additionally be stored with regard to these.

In the framework of adapting the representation of the information parameters and/or the presentation options, in particular for the information acquisition and/or processing, these parameters and options can be shown to a user, in particular for modification and/or selection. In the inventive method, advanced presentation techniques can be provided in that, for example, an optimized set of parameters and presentation options is provided using prior knowledge of a user. This can occur on the one hand in that a specific selection of such (possibly modifiable) parameters and options is provided to the user, and on the other hand in that a representation of the contents of the patient record is provided directly after an input and the documents that were recognized as relevant are marked with regard to the predetermined attributes.

The parameters or, respectively, presentation options can be grouped as protocols, whereby the user can define the entire acquisition or, respectively, post-processing process according to his desires via a possible modification. For example, in the framework of such a protocol, the user can select specific prior knowledge that is then used in the following for the location and presentation of the relevant information of the patient record, for example via specification of a specific knowledge databank which should be accessed. Moreover, pre-processing steps, strategies for fitting of data, the selection of presentation parameters as well as the selection of qualification parameters, the selection of presentation modes and presentation options (such as, for example, colors, the activation and deactivation of interpolations etc.) can be defined on the part of the user. As a result, the user can not only provide individual parameters for the presentation and the limitation or, respectively, identification in the information acquisition and processing; rather, the user can additionally input algebraic expressions or Boolean expressions for various parameters himself or herself in order to influence the location and the presentation of the information via a corresponding protocol.

Via prioritization (in particular on the basis of provided and/or acquired knowledge) the algorithm can adapt the presentation of the information provided to a user given a new input and/or a new query. For example, using provided or previously acquired knowledge, it can thereby be established which information of the patient record should initially be displayed with regard to a specific diagnostic question and specific symptoms. The order of the information presentation is influenced in a corresponding manner, for example being presented in the order according to its relevance.

Moreover, the invention concerns a device or apparatus for location and presentation of information in at least one electronic patient record, the information being relevant to a user, in particular to a physician for supporting a decision). The device of a preferred embodiment is characterized in that it comprises a data processing device with a self-learning, intelligent algorithm that is fashioned for adaptation, depending on data received via at least one input of information and/or upon one retrieval of information from at least one electronic patient record by a user, of the content and/or the presentation of the information provided to a user given a new input and/or a new query.

The device or apparatus thus comprises a data processing device that can be organized as a stationary or mobile single computer or as a network of client computers and server computers. The data processing device includes a self-learning, intelligent algorithm that is implemented or, respectively, capable of running to access the information of one or more electronic patient records and additionally has available at least in part the data regarding the input of this information or its retrieval in order to learn using these data and this information. The preliminary work or, respectively, the efforts of earlier users can thus be used and further processed by the algorithm in the inventive device such that they enter into the later presentation of the contents of the electronic patient record or also affect the contents themselves. The electronic patient record is thereby stored on a storage device (for example on a network), whereby this can be a central server but also an individual computer or a chip card or the like. The electronic patient record possibly interacts with a databank, such as a further storage device (that can be physically identical to the storage for the patient record) in which are stored the data regarding the accesses to the patient records.

If a physician accesses the electronic patient record in a subsequent examination, the information presented to the physician changes according to the learning process that the algorithm has run through, dependent on the preceding inputs and queries.

In the device, a databank can be provided for structured storage (in particular under generation of a log file) of data regarding the input and/or the retrieval of information. Data regarding information retrieval are thus stored in a databank or, respectively, a log file structured according to specific specifications or, respectively, dependent on the leaning process of the algorithm, in particular with connections between patient attributes and typical contents of the electronic patient record.

Furthermore, the device can comprise: a user interface for user-side input and/or for retrieval of information and/or data; and/or at least one data storage unit for data storage; and/or at least one device for reading and/or writing of electronic storage media; and/or at least one electronic storage medium, in particular an electronic chip card.

Via a user interface (for example in the form of a computer monitor with a keyboard and a mouse or, respectively, an associated control program) a user can make inputs in order to add new documents to the electronic patient record or to retrieve existing information. For example, symptoms can be input into a specific program means for access to the electronic patient record that includes input fields or the like for receiving the information.

Furthermore, a data storage unit can be present (possibly in addition to an existing databank) in order to store further or, respectively, additional data with regard to the information input and the retrieval of information of the patient record. In the event that, for example, a central databank is present, this data storage unit can be local storage units on which is possibly stored a selection of data with regard to the information retrieval or, respectively, the information input or, respectively, on which such data are stored exclusively or upon selection.

If, for example, an electronic patient record is combined with a chip card, it is appropriate when the device comprises not only a reader for such a chip card but additionally enables a writing of this card, be it for correction of information or for storage of access information on the chip card or another storage medium (for example a storage card of a PDA (Personal Digital Assistant) or the like). Typical storage media in the medical field that can appropriately be integrated into the device are electronic health cards as well as electronic physician identification cards and the like.

The location and presentation of information of an electronic patient record can thus be significantly simplified with the inventive method or, respectively, the inventive device. This enables the existing data or, respectively, information to be accessed quickly in the case of an emergency and additionally contributes to avoiding possible duplicate examinations and avoiding a multiple storage of information or, respectively, a storage of contradictory information for better utilization of the capacities of a data processing system.

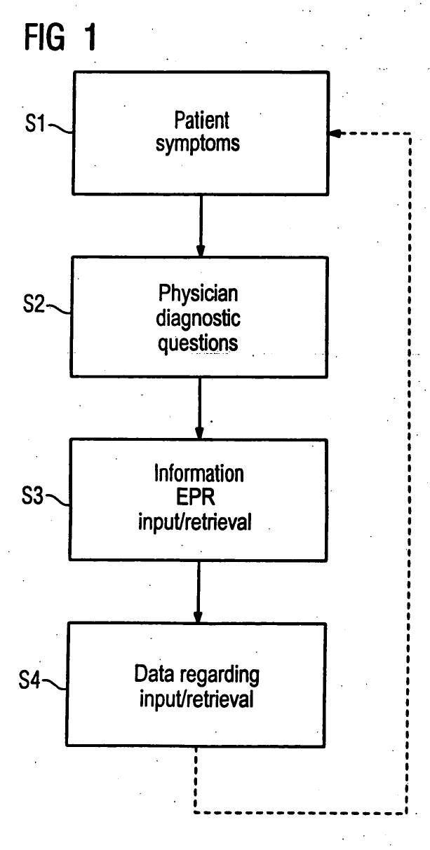

With reference to the figures, the workflow of an inventive method is shown in FIG. 1. A patient with specific symptoms or, in the framework of a post-examination, a physician thereby initially searches in a step S1.

In step S2, possibly after an interview of the patient or a first examination, the physician thereupon defines a set of diagnostic questions that are necessary for a decision about a further therapy or, respectively, a treatment. These questions are based on the symptoms of the patient as well as the knowledge of the physician with regard to the treatment of patients with similar symptoms as the current patient has recited them in a step S1.

In step S3 the physician accesses an electronic patient record (EPR) on a storage unit to input the diagnostic questions and to retrieve information. For this the physician uses his or her identification or, respectively, an electronic health card or the like on which is possibly stored a preview portion or other partial or complete information of the documents, files and information of the electronic patient record of the respective patient.

Based on the diagnostic questions defined in the step S2, the physician additionally employs examinations (in particular given lack of corresponding information in the electronic patient record) that lead to images, text documents, film exposures and the like that are input into the electronic patient record on the part of the physician or are stored in the patient record. With regard to the input of information or, respectively, the retrieval of information into or from the electronic patient record that is implemented on the part of the physician in the step S3, data regarding the input or, respectively, the retrieval are stored (for example in a databank) in the step S4. Additionally or alternatively such data can be stored on a chip card, such as the electronic chip card.

When the patient calls on the physician again or calls on a different physician or, respectively, a further patient calls on a physician, the steps S1-S4 are run through again, whereby the presentation of the information from the electronic patient record in step S3 is influenced by the previous input or, respectively, the previous retrieval such that an adaptation by the self-learning, intelligent algorithm of the invention ensues dependent on the prior inputs or, respectively, the prior retrieval. For example, this means that in step S2 the diagnostic questions do not have to be wholly re-input given a presence of identical or comparable symptoms but rather can be adopted from a preceding physician, whereupon the information retrieved at that time is shown in step S3. For example, the presentation of the image data is thereby organized dependent on the retrieval of the documents. In order to enable an optimized information input or, respectively, an optimized retrieval of information, data of various physicians regarding the inputs or, respectively, the retrieval of information from the electronic patient record can be combined in a similar manner given a new pass through the steps S1-S4.

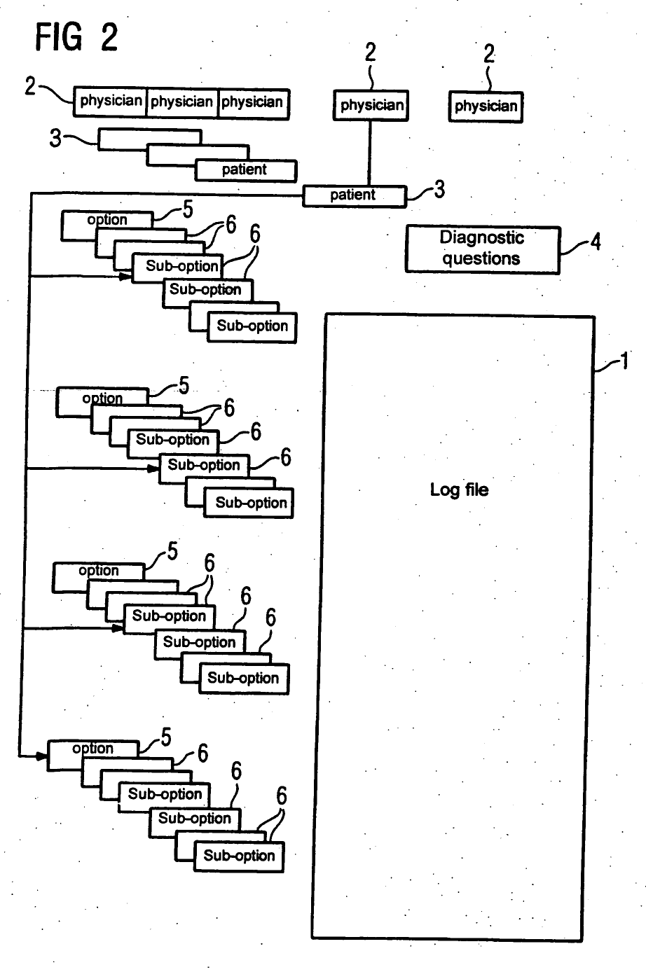

A presentation for determination of a log file 1 in an inventive method is shown in FIG. 2. Various physicians 2 are hereby called on by one or possibly various patients 3, whereby the patient 3 respectively indicates symptoms for which the respective physician defines diagnostic questions or, respectively, adopts them from other physicians (here indicated by the small boxes 2).

In the framework of the examination the physicians 2 respectively access the electronic patient record of the patient 3 which comprises information in the form of different documents, files and the like. The indices of these files which are in the electronic patient record of the patient 3 present options 5 as well as sub-options 6 that relate to various attributes of the patient such as his demographic data stored on a health card, the patient's symptoms or, respectively, the diagnostic questions and the like according to the box 4.

Overall the work steps of the various physicians 2 results in a log file 1 in which data are stored for the patient 3 and that is organized according to the individual physicians 2 who have respectively treated the patient, which data relate to the access to the electronic patient record.

For example, for a specific physician 2, the log file 1 thus contains the symptoms recited by the patient 3 and the defined diagnostic questions according to the box 4 and as a result the options 5 and sub-options 6 that reference the files of the electronic patient record that were queried or, respectively, the files that were newly added by this physician. In a next examination by a further physician 2, the patient 3 possibly presents new symptoms that in part coincide with the symptoms specified in the first examination with the first physician 2. The physician 2 correspondingly receives a presentation of the information of the electronic patient record that is already adapted by the self-learning, intelligent algorithm to the requirements to be concluded from the first examination. The physician 2 of the subsequent examination adds further files to the electronic patient record, regarding which further files the options 5 and sub-options 6 are in turn stored in the log file 1. An optimized location and an optimized presentation of the data of the electronic health record of the patient 3 for a plurality of symptoms and diagnostic questions is achieved bit by bit via the leaning process as well as the continuous training of the algorithm.

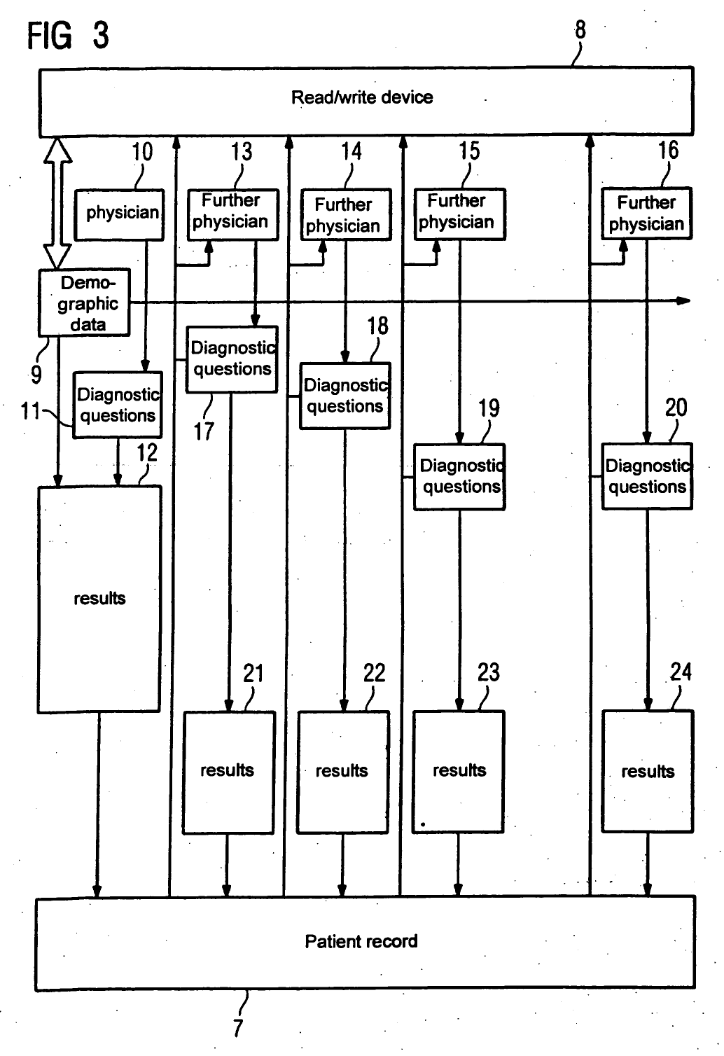

FIG. 3 shows a presentation for input or, respectively, for retrieval of information of an electronic patient record 7 given the present inventive method. The electronic patient record 7 hereby comprises a header (not shown in detail) with the data that concern the retrieval or, respectively, the input of information in the file 7.

A memory chip of the patient (such as a smart card or, respectively, a memory card of a mobile telephone or the like) is read in via a read and write device 8. A self-learning, intelligent algorithm that concerns the treatment and examination steps implemented by physicians for the respective patient is moreover present on the memory card that is inserted into the read and write device.

The demographic data 9 of the patient are initially read out in the read and write device via an input of the memory chip. A physician 10 who was called upon by the patient defines diagnostic questions 11 that relate to the symptoms described by the patient or that are seen in the patient. As a result, examinations are conducted that lead to results 12 which are, for example, image files of exposures with a magnetic resonance apparatus or a computer tomograph or, respectively, pathological findings that are input into reports or via specific markings in image data. A series of image, text, video and further data are acquired overall as results 12.

The results 12 are added to the electronic patient record 7, whereby information regarding access to the record is stored in its header. The patient may subsequently calls on further physicians 13, 14, 15 and 16 who in turn define diagnostic questions 17, 18, 19 and 20 or, respectively, at least partially access already-existing questions. For example, given the presence of comparable or identical symptoms that become known to the physician 15 the diagnostic question 17 of the physician 13 is adopted by the physician 15, which diagnostic question 17 is provided to the physician 15 from the data of the electronic patient record 7.

The physicians 13, 14, 15 and 16 for their part conduct examinations that lead to results 21, 22, 23 and 24 that are in turn stored in the electronic patient record 7. The data that relate to the workflow of the individual physicians 10, 13, 14, 15 and 16 (thus the data that concern the input or, respectively, the retrieval of information of the electronic patient record 7) are stored the same in the header in order to thus achieve an optimized presentation of the contents adapted by the algorithm (in particular via an organization of the order or via a selection or prioritization) for the respective physician 10, 13, 14, 15 and 16 given a new access to the electronic patient record 7.

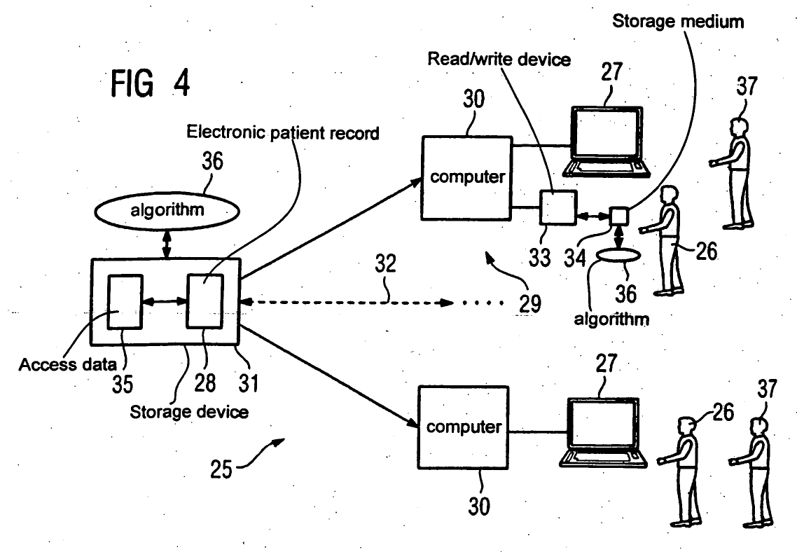

An inventive device or system 25 is shown in FIG. 4 with which physicians 37 respectively access an electronic patient record 28 via user interfaces 27 on an image output means with an input device. The inventive device 25 comprises a data processing device 29 that, in addition to various computers 30 at the individual physicians 26, possesses a storage device 31 on which the electronic patient record 28 is stored.

Connections to further physicians (not shown here) with their own respective computers 30 are indicated by the double arrow 32. In addition to this a read and write device 33 via which a storage medium 34 is read or, respectively, written is present at least at some physician's facilities 26. The electronic patient record 28 can likewise be stored wholly or in excerpts on the storage medium 34.

An authentication that enables the access to the electronic patient record 28 is enabled via the storage medium 34 just as via a corresponding input at the user interface 27. The electronic patient record 28 comprises various information such as image files or findings or the like that were input by various physicians 26. If the electronic patient record 28 is now accessed, data with regard to this access are thus created that are stored as access data 35 in the storage device 31. These data are additionally or alternatively stored on the storage medium 34. The access data 35 are thereby structured (in this case using a databank structure) such that a self-learning, intelligent algorithm 36 that is stored on the storage medium 34 or, respectively, on a storage and computation device in connection with the storage device 31 can work with these data.

The self-learning, intelligent algorithm 36 processes the workflows given the individual accesses to the electronic patient record 28 by the physicians 26 that the patient 37 visited and learns from this, such that the input field presentation given a new access is adapted to the existing access data 35.

For example, given input of the symptoms via the user interface 27, diagnostic questions are already provided to a physician 26 or, respectively, the physician receives a display of possibly relevant data and the like. The self-learning, intelligent algorithm 36 can be patient-specific or, respectively, it can be an algorithm that comprises information regarding various patients. Combinations are additionally possible in which the algorithm 36 is present at a central location as a patient-spanning algorithm on the one hand, on the other hand can be combined with a patient-specific algorithm on a storage medium 34.

Overall a simple location and presentation of the decision-relevant information of an electronic patient record 28 is possible via the inventive device, for example in an emergency case.

Although other modifications and changes may be suggested by those skilled in the art, it is the intention of the inventors to embody within the patent warranted hereon all changes and modifications as reasonably and properly come within the scope of their contribution to the art.

I claim:

1. A method for location and presentation of information in at least one electronic patient record that is relevant to a user, comprising the steps of:
receiving at least one of a new input and new query, and
adapting at least one of content and presentation of information provided to a user depending on data of at least one of input of information into the at least one electronic patient record and query for retrieval of information from the electronic patient record by a user, said adapting step being performed automatically by a self-learning intelligent algorithm of a data processing device

2. A method as claimed in claim 1, wherein said user is a physician seeking support for a decision.

3. A method according to claim 1, further comprising the steps of:
storing structured data with regard to at least one of said input of information and retrieval of information in a databank.

4. A method as claimed in claim 3, wherein said storing step includes generating at least one log file.

5. A method according to claim 3, wherein said step of adapting is performed by said self-learning intelligent algorithm to adapt at least one of content and presentation of the information based on the structured stored data of the databank.

6. A method according to claim 1, further comprising the step of:
establishing relationships between data regarding at least one of input information and retrieval of information and accesses to information and acquired knowledge for adapting at least one of content and presentation by said self-learning intelligent algorithm.

7. A method as claimed in claim 1, wherein the data with regard to input or retrieval of information includes data selected from: data of an electronic patient record, data of patient attributes, data regarding a presentation type of information defined by a user, data regarding data flow from or to the electronic patient record, and data regarding user preferences.

8. A method as claimed in claim 7, wherein said patient attributes includes data selected from: symptoms, diagnostic questions, data regarding documents of an electronic patient record requested by a user, and data regarding documents stored in the electronic patient record after a follow-up examination.

9. A method according to claim 1, further comprising the step of:
determining a protocol for at least one of learning and training and data prediction by said self-learning intelligent algorithm.

10. A method according to claim 9, wherein said protocol is determined using at least one of a neural network and adaptive filter techniques and Bayesian techniques and a genetic algorithm.

11. A method according to claim 1, further comprising the step of:
storing said data with regard to at least one of input and retrieval on a storage medium.

12. A method as claimed in claim 11, wherein said data with regard to at least one of input and retrieval includes a log file stored as a header of the electronic patient record.

13. A method as claimed in claim 11, wherein said storage medium includes an electronic chip card.

14. A method according to claim 1, further comprising the step of:
showing adaptations of at least one of presentation of the information and parameters and presentation options to a user.

15. A method according to claim 1, wherein said adapting step includes said self-learning intelligent algorithm using prioritization to adapt the presentation of the information provided to a user.

16. A method as claimed in claim 15, wherein said adapting step is on a basis of at least one of predetermined and acquired knowledge.

17. An apparatus for location and presentation of information in at least one electronic patient record, comprising:
a data processing apparatus;
a self-learning intelligent algorithm operable on said data processing apparatus;
an input and an output of said data processing device at which input information is received and response information is provided, respectively,
said self-learning intelligent algorithm being operable to adapt at least one of content and presentation of information provided to a user upon a new input or a new query, said adapting depending on data regarding at least one of input of information and retrieval of information from the at least one electronic patient record by a user.

18. An apparatus according to claim 17, further comprising:
a databank for structured storage of data with regard to at least one of input and retrieval of information.

19. An apparatus according to claim 17, further comprising:
a user interface for at least one of user-side input and retrieval of information and data; and
at least one of: a data storage unit for data storage and a device for reading and writing of electronic storage media and an electronic storage medium.
